(19) United States
(12) Patent Application Publication
(10) Pub. No.: US 2014/0149519 A1
(43) Pub. Date: May 29, 2014

(54) MEETING ROOM STATUS BASED ON ATTENDEE POSITION INFORMATION

(71) Applicant: LINKEDLN CORPORATION, Mountain View, CA (US)

(72) Inventors: Joff Redfern, Truckee, CA (US); Jayant Sai, Mountain View, CA (US)

(73) Assignee: Linkedln Corporation, Mountain View, CA (US)

(21) Appl. No.: 13/688,002

(22) Filed: Nov. 28, 2012

(51) Int. Cl. H04L 29/06

(52) U.S. Cl. CPC H04L 65/403; H04L 51/04
USPC 709/206; 709/204

(57) ABSTRACT

A system may include a processor and a network interface. The processor may be configured to set a meeting room status of a meeting room over a selected time period to unavailable based on a meeting organizer specifying the time period and an attendee of a meeting, obtain a location status of the attendee during the selected time period, and change the meeting room status to reserved but not occupied based on the location status of the attendee being not in proximity of the meeting room. The network interface may be configured to transmit the meeting room status to a user device.

### TECHNICAL FIELD

The subject matter disclosed herein generally relates to the management of meeting room resources based on meeting attendee location.

### BACKGROUND

Meeting rooms, such as can be located in business and public venues, have long incorporated network-based resource management. Commonly available commercial software can be utilized to allow users of the software to reserve meeting rooms and see what meeting rooms may be available for future reservation or current use. Such software is commonly available on ubiquitous consumer electronics, such as personal computers, smartphones, personal digital assistants (PDAs), and the like.

### BRIEF DESCRIPTION OF THE DRAWINGS

Some embodiments are illustrated by way of example and not limitation in the figures of the accompanying drawings.

FIG. 1 is a block diagram of a system including user devices and a social network system.

FIG. 2 is a block diagram illustrating an example of a social networking system, including a recommendation engine.

FIG. 3 is a block diagram showing some of the functional components or modules that comprise a recommendation engine.

FIG. 4 is a detailed optional example of a social network system.

FIG. 5 is a flowchart for generating and transmitting a meeting invitation to a user device of a member of a social network.

FIG. 6 is a block diagram illustrating components of a machine able to read instructions from a machine-readable medium.

### DETAILED DESCRIPTION

Example methods and systems are directed to user profile and geography-based meetings. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

While meeting room management software may allow for meeting room scheduling and availability, such software may not effectively track actual meeting room utilization and may do little to facilitate attendance at meetings that have previously been scheduled. Such meeting room software may provide a reminder prior to, at, or after the time at which the meeting room was reserved, but such reminders may simply be general reminders and my not be directed with particularity to meeting attendees who are not actually in the meeting room. In general, such meeting room management software may not be sensitive to how a meeting room is actually being utilized and what the behavior of the attendees actually is.

An application has been developed to manage meeting rooms based on the presence in the meeting room, or lack thereof, of scheduled attendees of the meeting. The application can allow users to check in, whether actively based on direct interaction with the application, or passively based on a position of a device corresponding to the attendee, to determine whether a meeting room is being used and which of the meeting attendees may not be present. Based on the attendance, a status of an availability of the meeting room may be updated and messages transmitted to absent attendees.

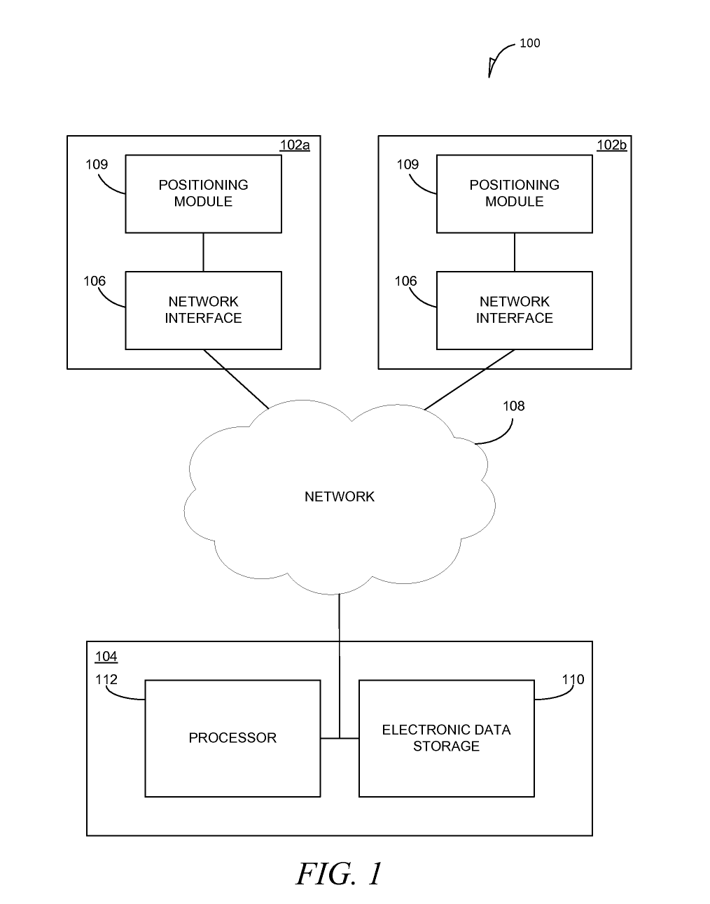

FIG. 1 is a block diagram of a system 100 including user devices 102 and a server 104. User devices 102 can be a personal computer, netbook, electronic notebook, smartphone, appliance, or any electronic device known in the art that is configured to display web pages. The user devices 102 can include a network interface 106 that is communicatively coupled to a network 108, such as the Internet.

One or more of the user devices 102 can further include a positioning module 109 that can identify a geographic position of the user device 102. In an example, the positioning module 109 incorporates an absolute position function, such as by utilizing the Global Positioning System (GPS) to determine, within a standard margin of error, an absolute geographic location. In an example, the positioning module 109 can utilize triangulation, such as by detecting wireless transmissions from cellular transmitters and identifying a relative position of the user device 102 based on a direction and intensity of the received signals, as well known in the art. In various examples, alternative positioning methods known in the art may be utilized, such as imaging of recognized landmarks.

The server 104 can be communicatively coupled to the network 108. The server 104 can be an individual server or a cluster of servers, and can be configured to perform activities related to serving the social network, such as storing social network information, processing social network information according to scripts and software applications, transmitting information to present social network information to users of the social network, and receive information from users of the social network. The server 104 can include one or more electronic data storage devices 110, such as a hard drive, and can include a processor 112.

The server 104 can store information in the electronic data storage device 110 related to the maintenance and scheduling of meeting rooms. For instance, the seating capacity and equipment of a meeting room can be stored in the electronic data storage 110. A current and future occupancy status can be noted, such as when the meeting room is scheduled to be or is currently occupied and when the meeting room is scheduled to be or is currently available. Meeting attendees who are in or who are scheduled to be in a meeting room can be recorded to assess who is on time for a meeting and who may be notified that they are late for a meeting, as is discussed below in detail. The physical location of a meeting room can also be recorded, whether having been manually uploaded or determined, such as by the processor 112, based on attendee behavior, as described herein.

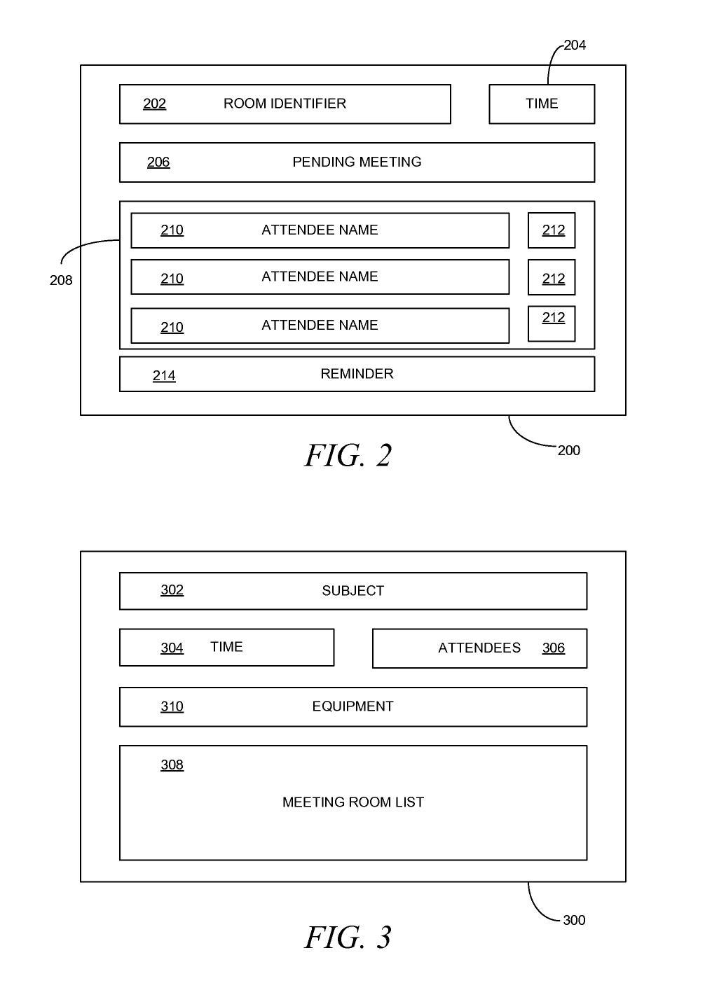

FIG. 2 is an abstract image of a meeting room management screen 200, such as can be displayed on a user device 102. In various examples, the management screen 200 is configured to be displayed on a user device 102 such as a cellphone or personal digital assistant (PDA). In various examples, the management screen 200 is configured to be displayed on a display unit, such as can be mounted on a wall or table or other permanent, semi-permanent, or moveable structure in or near a meeting room. Such a display unit such as can include a monitor and an input system such as a touchscreen or keyboard.

The management screen 200 as illustrated includes a meeting room identifier field 202 that can provide information that can identify the meeting room, such as a name and/or a location of the meeting room; a time field 204 that can display a current time; a pending meeting field 206 that can display information related to a meeting that is either next to occur or that is currently in progress; and attendee fields 208 that can list attendees of the pending meeting. Each attendee field can include a name field 210 to list a name or other identifier of the corresponding attendee and can further include a check in/check out button 212. The button 212 can be a toggle button, wherein selecting the button 212 flips the state of the button. In various examples, check in/check out functionality can be applied to the attendee field 208 as a whole, so that selecting the field toggles the check in/check out status of the attendee.

In various examples, the management screen 200 is populated according to general meeting room reservation software. When a meeting organizer reserves a meeting room, the meeting room reservation software takes note of a meeting subject or title as well as attendees for the meeting. When the subject meeting becomes the pending meeting for the meeting room, the management screen 200 can be populated with the name/subject for the meeting and the attendees of the meeting. The default for populating check in/check out button 212 for each attendee can be that the attendee is checked out.

Upon arriving at the meeting room for the pending meeting, the status of each attendee can be toggled from checked out to checked in. In an example, each attendee or representative of each attendee can utilize the device on which the management screen 200 is displayed to toggle their status from checked out to checked in using the button. Such a process can be done on any device on which the management screen 200 is or can be displayed. Thus, if a management screen 200 is displayed on a user device 102 fixed or otherwise located in or near the subject meeting room, each attendee can utilize the device to check in upon arriving at the meeting. In various additional examples, the management screen 200 can be displayed on a personal user device 102 of some or all attendees, and checking in may be achieved by some or all of the attendees toggling their status on their personal user devices 102.

In various examples, checking in can be achieved by utilizing positional information from the positioning module 109 of an attendee's personal user device 102. As will be discussed herein in greater detail, when the positioning module 109 registers that the attendee is within the meeting room or is in close proximity of the meeting room, the user device 102 can access the management screen 200 or underlying application logic and automatically switch the attendee's status from checked out to checked in. Relatedly, an attendee can be checked out of a meeting room by manually toggling the button 212 on the management screen or by the positioning module 109 noting that the attendee has left the meeting room.

Based on a check in/check out status of the attendees of a meeting, the system 100 generally can register a current utilization of the subject meeting room. The management screen 200 can display a current status of the meeting room. A meeting room in that is “reserved” but to which none of the attendees have shown up to within a time window of the appointed meeting time can be registered as being “reserved but unoccupied” or “available” for a meeting. Similarly, a meeting that was attended but which is registered as having broken up because some or all of the attendees have checked out from the meeting prior to the scheduled finishing time of the meeting can also be registered as being reserved but unoccupied or available, the previously established schedule for the meeting room notwithstanding.

The check in/check out status of meeting attendees in relation to the scheduled starting time of a meeting can also be utilized to serve messages, such as reminders and/or queries, to the attendees who have not checked in. In various examples, the management screen 200 can include a reminder field 214 to provide reminders of the meeting to attendees who are not checked in. The reminder field 214 can be displayed on all instances of the management screen 200, or can be unique to management screens 200 displayed on user devices 102 corresponding to non-checked in attendees. In other words, a management screen 200 that is displayed on a device 102 mounted in a meeting room may not display the reminder field 214, while a management screen 200 displayed on the personal user device 102 of a non-checked in attendee may include the reminder field 214. The user devices 102 can be configured, using existing device 102 hardware, to provide audio reminders corresponding to the reminder as displayed in the reminder field 214, such as by sounding an alert tone or verbal message.

The reminder 214 field may be configured to display messages generally. Such messages can include queries rather or in addition to a reminder. For instance, the query may question the intention of a listed attendee to actually attend the meeting. The query may question the meeting organizer if the meeting will actually occur, such as if none of the meeting attendees are in or in proximity of the meeting room. The meeting room status can be changed based on the response to the queries.

Additionally or alternatively, the system 100 can transmit messages to attendees who have not checked in via other communication modalities. In various examples, the system 100 can transmit a reminder and/or query via text message, email, and other communication modalities known in the art. Such messages can be timed to be transmitted a predetermined intervals, such at a scheduled meeting time, five (5) minutes following the scheduled meeting time, and fifteen (15) minutes following the scheduled meeting time. In various examples, the system 100 can incorporate default predetermined reminder times and/or can permit, for instance, a meeting organizer to determine reminder times.

The various communication modalities, including the reminder field 214, can be utilized to facilitate responses to queries. In response to a query such as “Will the meeting occur?”, the reminder field 214 specifically or the management screen 200 generally may display an interface to allow a user to choose “yes” or “no” or a related selection known in the art. A user may respond to a text message or email with an appropriate answer, such as can be facilitated by email programs known in the art.

In various examples, one or more of the reminder times or another predetermined time can be utilized to change a status of a meeting room from “reserved” to “reserved but not occupied” to “available” based on an insufficient number of attendees having checked in. In an example, if no attendees or only one attendee has checked in within fifteen (15) minutes of the appointed starting time of the meeting, the reservation status of the meeting room may change from reserved to reserved but not occupied. In various examples, if all of the meeting attendees respond to an attendance query that they will not attend, or if a meeting attendee or organizer responds that the meeting will not occur, or if enough meeting attendees do not respond to the query at all within a predetermined time period, the meeting room status may be set to available. In various examples, the management screen 200 can provide a selection to override changing the status of the meeting room for an attendee to prevent the status changing from reserved to available, or vice versa.

FIG. 3 is an abstract image of a meeting room scheduling screen 300, such as can be displayed on a user device 102. As illustrated, the meeting room scheduling screen 300 incorporates a meeting subject field 302, a meeting time field 304, and an attendees field 306. In various examples, the meeting room scheduling screen 300 can incorporate or not incorporate any of the above fields 302, 304, 306 and can incorporate any additional fields. In the illustrated example, the meeting room scheduling screen 300 optionally further includes a meeting room list 308 of available meeting rooms. The list 308 can be populated based on all available meeting rooms or can be narrowed down based on meeting room availability and given the parameters inputted in the fields 302, 304, 306.

In various examples, the meeting time field 304 can be utilized to specify a meeting time in the future or can be utilized to specify a meeting to occur immediately. In various examples, the meeting time field 304 can include a dropdown menu of meeting times include “immediate” and at various intervals, such as on the quarter hour or on the half hour. The meeting time field 304 can also include a meeting duration time. In addition to dropdown menus, the meeting time field 304 can include fields to allow the manual input of meeting times and durations.

In various examples, the meeting attendees field 306 can provide for entering specific attendees, such as according to name, email address, and other data that can identify an individual attendee known in the art. In various examples, the meeting attendees field 306 does not require specifying individual attendees, and instead can permit a meeting organizer to specify a total number of attendees. Specifying a total number of attendees can, in various example uses, be utilized to specify a snap meeting to happen immediately with a number of people who are immediately at hand to the meeting organizer Thus, a meeting organizer who is in a group of, for example, five people who needs to find a meeting room immediately available might enter “immediate” in the meeting time field 304 and “5” in the meeting attendees field 306, and may be provided with a list of meeting rooms in the meeting room list 308 that are currently available and that have a seating capacity for at least five (5) people.

As alluded to in the above example, the system 100 can utilize the data entered in the fields 302, 304, 306 to cross reference the desired meeting characteristics against meeting room resources. In various examples, the meeting room list 308 can be populated with some or all of the eligible meeting rooms that meet the meeting criteria. In such examples, the meeting organizer can select a suitable meeting room. In various alternative examples, the system 100 can automatically assign a meeting room for the meeting and notify the identified attendees which meeting room has been assigned via the meeting room list 308.

In various examples, the system 100 can utilize position information from the positioning module 109 of the meeting organizer to select a meeting room or to organize the available meeting rooms in the meeting room list 308. In various examples, the system 100 selects the closest meeting room to the position of the user device 102 of the meeting organizer for the meeting, or arranges the meeting rooms in the list 308 according to proximity. In various examples, a proximity of a meeting room can be a factor in the selection of a meeting room or the population of the list 308. In such examples, other factors, such as a conformity of the number of attendees to the size of the meeting room may also be factored in to the selection of the meeting room or the ordering of the list 308. In an example, if there are five (5) meeting attendees then the closest meeting room with the seating for at least five (5) people but not more seating than, in an example, three (3) more than the attendees is selected or displayed. In various examples, the meeting scheduling screen 300 can optionally include a field to specify a maximum seating capacity for the meeting room. In various examples, the seating capacity of a meeting room is not factored in to the selection or ordering of the list 308. In various examples, only a minimum seating capacity is factored in to the meeting room selection or ordering the list.

The meeting scheduling screen 300 optionally includes a meeting room equipment field 310. In various examples, a meeting organizer may specify particular needed equipment for the meeting room, such as a display projector or video conference capabilities, for instance. In various examples, the desired meeting room equipment can be cross-referenced against the equipment known or expected to be present in the various meeting rooms. The meeting room equipment field 310 can incorporate menus or text fields to manually enter desired equipment. In various examples, availability of equipment can be factored into the selection or ordering of meeting rooms.

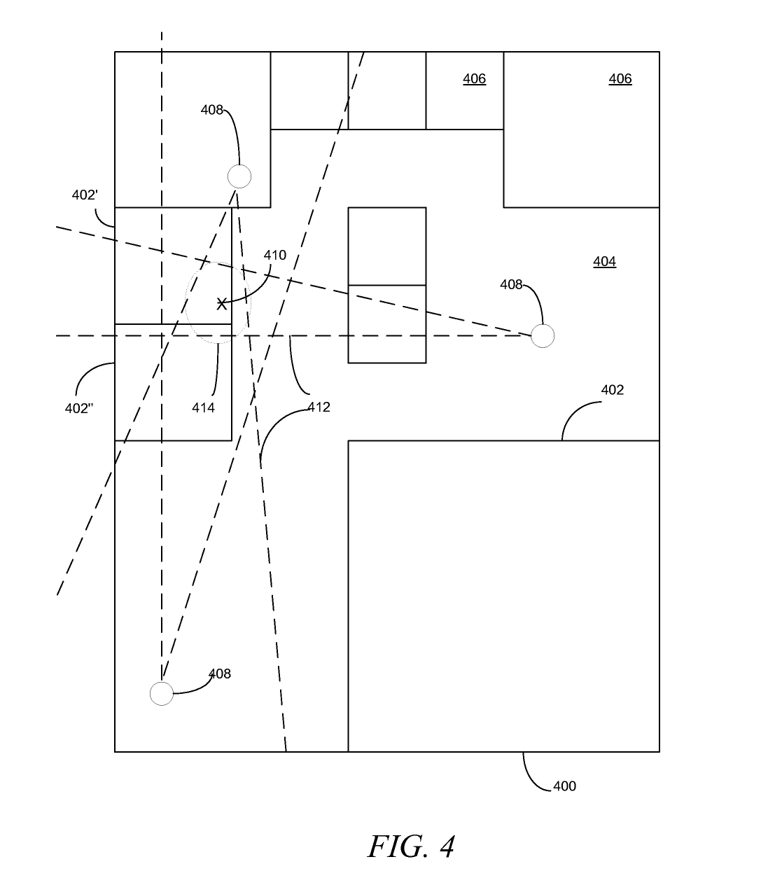

FIG. 4 is a diagram of a floor plan 400 including meeting rooms 402, corridors 404, private rooms 406, and wireless transmitters 408. A position of a meeting attendee 410 and a corresponding user device 102 having a positioning module 109 is marked.

Based on information from the positioning module 109, the system 100 can identify a location of the user device 102 and, by extension the attendee 410. In various examples, the system 100 can compile positional information from various attendees and cross-reference the positional information against meetings that the attendees are known to have attended. In the present illustrative example, if the attendee 410 is known to be attending a meeting in the meeting room 402′, and the positional information from the positioning module 109 indicates a particular location at the time of the meeting, the position information from the positioning module 109 can be utilized by the system to register a physical location of the meeting room 402′. In this way, and by factoring in position and schedule information at multiple different times and/or by multiple different attendees, detailed position information corresponding to some or all of the meeting rooms 402 of the floor plan 400 can be obtained and utilized to automate check in/check out procedures and identify vacant meeting rooms 402, as described above.

As noted on the floor plan 400, the user device 102 of the attendee 410 is within a meeting room 402′. However, as is known in the art, the position information provided by the positioning module 109 can include error. A GPS module of the positioning module 109 may not be accurate to more than three (3) meters or more. If the positioning module utilizes triangulation, such as against the signals received from the wireless transmitters 408, the precise direction of the various wireless signals can incorporate error, as denoted by the marked error bands 412. Consequently, in various examples, the positioning module 109 may provide a margin of error such that the position of the attendee can only be identified within the position error boundary 414.

As is apparent from the floor plan 400, while the attendee is actually in the meeting room 402′, the error from the positioning module 109 may place the attendee in a different meeting room 402″ or in the corridor 404. Consequently, the system 100 may not register the attendee 410 as being in the proper meeting room 402′ for the purposes of checking the attendee 410 in or out, or may deem an otherwise vacant meeting room 402″ to be occupied when the other meeting room 402″ should be deemed to be vacant.

In various examples, the potential error boundary 414 can be factored in for identifying a physical location of an attendee 410 and meeting rooms 402. In an example, if the system 100 cannot identify a location of an attendee 410 sufficiently to associate the attendee with a particular meeting room 410, then check in/check out and meeting room availability may not be enabled. In various examples, where the system 100 notes consistent and predictable error, such as position information that indicates a position within a corridor 404 actually equates to being within a particular meeting room 402″, then the system 100 can automatically compensate for future circumstances where such inaccurate position information is obtained.

In various examples, when an attendee 410 enters a vacant meeting room 402, such as meeting room 402″, the system 100 may denote the meeting room 402″ as being occupied, even though not meeting had been formally scheduled for the meeting room 402″. In various examples, the meeting room 402″ may be deemed to be available if a meeting organizer seeks to formally schedule a meeting room 402 but no other unoccupied meeting rooms are available. Stated another way, an attendee 410 may enter and utilize a vacant meeting room 402″ without formally scheduling a meeting in the vacant meeting room 402″, but if a meeting organizer has a need for the meeting room 402″, such as because no other suitable meeting rooms are available, the formal scheduling of the meeting room 402″ may preempt the ad hoc, unscheduled use of the meeting room 402″.

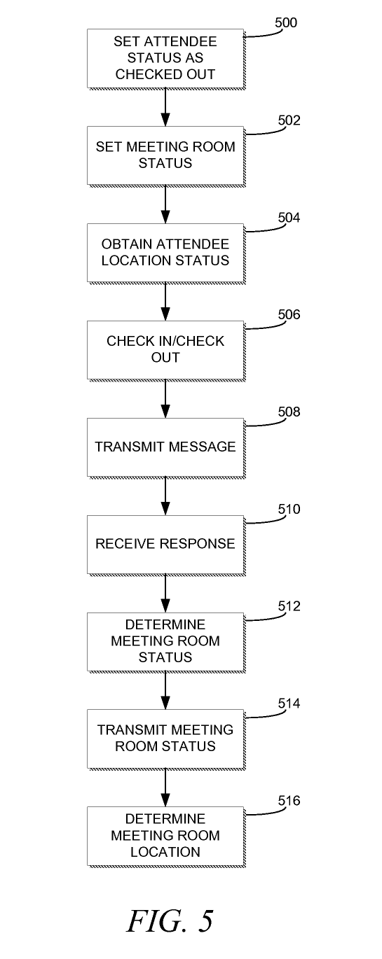

FIG. 5 is a flowchart for determining a meeting room status based on position information of a meeting attendee. While the flowchart will be described with respect to system 100 in particular, the flowchart is applicable to any suitable system or hardware.

At 500, a location status of a meeting attendee 410 is set as checked out. The meeting status as checked out can be a default until the meeting attendee checks in.

At 502, meeting room status of a meeting room 402 is set over a selected time period to unavailable based on a meeting organizer specifying the time period and an attendee 410 of a meeting. In various examples, the meeting organizer specifies multiple attendees 410. In various examples, the meeting organizer is one of the attendees 410. The time and attendees 410 can be specified on the meeting scheduling screen 300.

At 504, a location status of the meeting attendee 410 relative to a meeting room 402 in which a meeting is scheduled is obtained. In various examples, the location status of each of multiple attendees 410 is determined during the selected time period. The location status of the attendee 410 can be based on position information from the positioning module 109 or can be based on the meeting attendee manually checking in or not upon or after arriving at the meeting room 402. In various examples, the position information from the positioning module can be based on an absolute position, such as can be based on an absolute position on Earth as determined by the Global Positioning System (GPS), or based on a relative position, such as relative to wireless transmitters 408, such as can be determined through triangulation methodologies known in the art.

At 506, the meeting attendee is checked in upon arriving in proximity of the meeting room and the meeting attendee is checked out upon leaving the proximity of the meeting room. In an example, checking in and checking out is based on a manual selection by the meeting attendee, such as via the button 212 on the management screen 200. In an example, the attendee is automatically checked in and automatically checked out based on a position information of the user device 102, such as can be obtained by the positioning module 109.

At 508, a message is transmitted to a user device 102 of the meeting attendee if the meeting attendee is not in proximity of the meeting room 402. The message can be transmitted if the attendee 410 has not checked in after a starting time of the meeting has elapsed. The message can be transmitted via various communication modalities, including a text message, an email, an audible tone, and the like. The message can be a reminder. The message can include a query regarding a prospective status of the meeting. Such a query can ask the attendee 410, such as the meeting organizer, whether the meeting will occur. The message can also or alternatively be displayed on the reminder field 214 of the management screen 200.

At 510, a response from the user device 102 to the query is received. The response can variably indicate that the meeting will take place or that the meeting will not take place.

At 512, a meeting room status of the meeting room 402 is determined. The meeting room status can be changed from reserved but not occupied based on the location status of the attendee being not in proximity of the meeting room. The meeting room status can be set to available based on the response indicating a cancellation of the meeting. The meeting room status can be based, at least in part, on the location status of the attendee 410. In various examples, the location status of the attendee 410 is based on a position information from the positioning module 109 or is based on the meeting attendee 410 having checked in, in which case the attendee 410 is deemed to be in the meeting room 402, or not checked in, in which case the attendee 410 is deemed to not be in the meeting room 402.

At 514, the meeting room status is transmitted to the user device 102, such as via a network interface of the server 104.

At 516, a location of the meeting room 402 is determined based, at least in part, on the position information of the user device and the meeting attendee having checked in. In an example, the meeting room 402 position is determined based on a position information of a user device 102 of the meeting attendee 410 when the meeting attendee 410 has checked in, i.e., the meeting attendee 410 is in the meeting room 402. The positioning information can be obtained from the positioning module 109. In various examples, the location of the meeting room 402 is based on position information from multiple user device 102 of multiple meeting attendees 410.

In various examples, the meeting room status can be determined as disclosed herein. In an example, a meeting room 402 is available if no attendees 410 are checked in to the meeting room 402 and the meeting room 402 is not reserved, or if the meeting room is reserved by a predetermined time after a starting time for the meeting has elapsed. In various examples, the status of the meeting room 402 can be unavailable if a meeting attendee 410 has checked in or if position information of the attendee 410 indicates that the attendee 410 is in the meeting room 402.

At 512, the meeting room 402 status is transmitted to a meeting organizer In various examples, the meeting room 402 status is transmitted by proposing the meeting room 402 to the meeting organizer based on a meeting room profile and a profile of the meeting, such as is entered by the meeting organizer on the management screen 200. In various examples, the meeting room profile includes at least one of a seating capacity and equipment of the meeting room and wherein the meeting profile includes at least one of a number of meeting attendees and desired equipment.

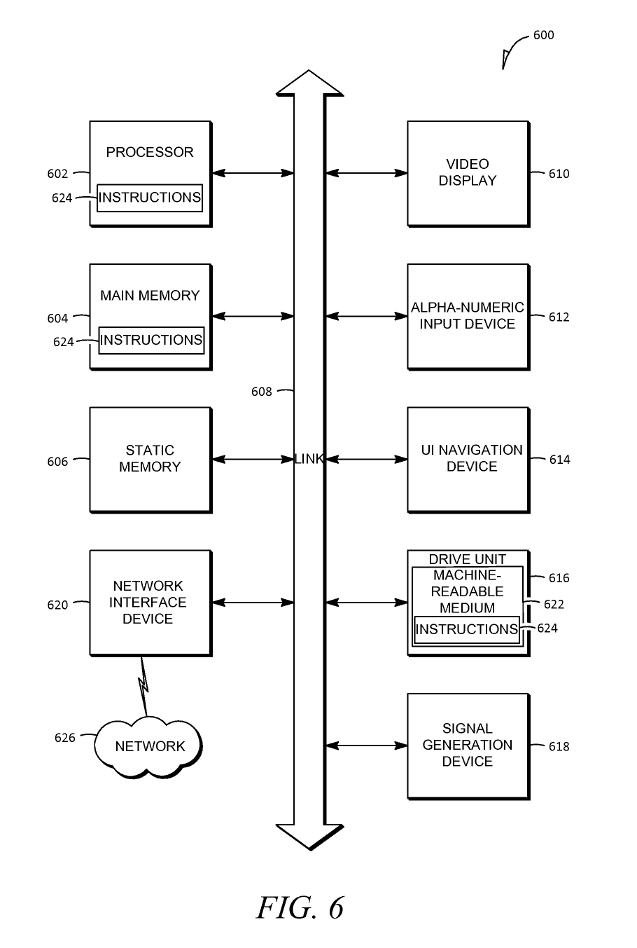

FIG. 6 is a block diagram illustrating components of a machine 600, according to some example examples, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software) for causing the machine 600 to perform any one or more of the methodologies discussed herein may be executed. In alternative examples, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A memory device, the memory device communicatively coupled to a processor and comprising instructions which, when performed on the processor, cause the processor to:
set a meeting room status of a meeting room over a selected time period to unavailable based on a meeting organizer specifying the time period and an attendee of a meeting;
obtain a location status of the attendee during the selected time period;
change the meeting room status to reserved but not occupied based on the location status of the attendee being not in proximity of the meeting room; and
transmit the meeting room status to a user device.

2. The memory device of claim 1, wherein the meeting room status is set based on the meeting organizer specifying the time period and a plurality of attendees of the meeting;
wherein the location status of each of the plurality of attendees during the selected time period is obtained; and
wherein the meeting room status is changed to reserved but not occupied based on the location status of none of the attendees being in proximity of the meeting room.

3. The memory device of claim 2, wherein the memory device further comprises instructions that further cause the processor to:
determine individual ones of the plurality of attendees who are not in the meeting room based on the location status of the individual ones of the plurality of attendees; and
transmit a message to a user device of each of the plurality of attendees who are not in proximity of the meeting room based on at least one of the plurality of attendees being in proximity of the meeting room.

4. The memory device of claim 1, wherein the memory device further comprises instructions that further cause the processor to:
transmit a message to a user device of the attendee based on the location status of the attendee not being in proximity of the meeting room.

5. The memory device of claim 4, wherein the message includes a query regarding a prospective status of the meeting, and wherein the memory device further comprises instructions that further cause the processor to:
receive a response from the user device to the query; and
set the meeting room status to available based on the response indicating a cancellation of the meeting.

6. The memory device of claim 1, wherein the memory device further comprises instructions that further cause the processor to determine the location status of the attendee based on:
the attendee checking in upon arriving in proximity of the meeting room; and
the attendee checking out upon leaving the proximity of the meeting room.

7. The memory device of claim 6, wherein the memory device further comprises instructions that further cause the processor to automatically check the attendee in and automatically check the meeting attendee out based on a position information of a user device of the meeting attendee.

8. A method, comprising:
setting a meeting room status of a meeting room over a selected time period to unavailable based on a meeting organizer specifying the time period and an attendee of a meeting;
obtaining a location status of the attendee during the selected time period;
changing the meeting room status to reserved but not occupied based on the location status of the attendee being not in proximity of the meeting room; and
transmitting the meeting room status to a user device.

9. The method of claim 8, wherein the meeting room status is set based on the meeting organizer specifying the time period and a plurality of attendees of the meeting;
wherein the location status of each of the plurality of attendees during the selected time period is obtained; and
wherein the meeting room status is changed to reserved but not occupied based on the location status of none of the attendees being in proximity of the meeting room.

10. The method of claim 9, further comprising:
determining individual ones of the plurality of attendees who are not in the meeting room based on the location status of the individual ones of the plurality of attendees; and
transmitting a message to a user device of each of the plurality of attendees who are not in proximity of the meeting room based on at least one of the plurality of attendees being in proximity of the meeting room.

11. The method of claim 8, further comprising transmitting a message to a user device of the attendee based on the location status of the attendee not being in proximity of the meeting room.

12. The method of claim 11, wherein the message includes a query regarding a prospective status of the meeting, and further comprising:
receiving a response from the user device to the query; and
setting the meeting room status to available based on the response indicating a cancellation of the meeting.

13. The method of claim 8, further comprising determining the location status of the attendee based on:
the attendee checking in upon arriving in proximity of the meeting room; and
the attendee checking out upon leaving the proximity of the meeting room.

14. A system, comprising:
a processor configured to:
set a meeting room status of a meeting room over a selected time period to unavailable based on a meeting organizer specifying the time period and an attendee of a meeting;
obtain a location status of the attendee during the selected time period; and
change the meeting room status to reserved but not occupied based on the location status of the attendee being not in proximity of the meeting room; and
a network interface configured to transmit the meeting room status to a user device.

15. The system of claim 14, wherein the meeting room status is set based on the meeting organizer specifying the time period and a plurality of attendees of the meeting;
wherein the location status of each of the plurality of attendees during the selected time period is obtained; and
wherein the meeting room status is changed to reserved but not occupied based on the location status of none of the attendees being in proximity of the meeting room.

16. The system of claim 15:
wherein the processor is further configured to determine individual ones of the plurality of attendees who are not in the meeting room based on the location status of the individual ones of the plurality of attendees; and
wherein the network interface is further configured to transmit a message to a user device of each of the plurality of attendees who are not in proximity of the meeting room based on at least one of the plurality of attendees being in proximity of the meeting room.

17. The system of claim 14, wherein the network interface is further configured to transmit a message to a user device of the attendee based on the location status of the attendee not being in proximity of the meeting room.

18. The system of claim 17, wherein the message includes a query regarding a prospective status of the meeting;
wherein the network interface is further configured to receive a response from the user device to the query; and
wherein the processor is further configured to set the meeting room status to available based on the response indicating a cancellation of the meeting.

19. The system of claim 14, wherein the processor is further configured to determine the location status of the attendee based on:
the attendee checking in upon arriving in proximity of the meeting room; and
the attendee checking out upon leaving the proximity of the meeting room.

20. The system of claim 19, wherein the processor is further configured to automatically check the attendee in and automatically check the meeting attendee out based on a position information of a user device of the meeting attendee.
